(19) United States
(12) Patent Application Publication
(10) Pub. No.: US 2019/0338667 A1
(43) Pub. Date: Nov. 7, 2019

(54) Automatic Turbocharger Cleaning Device

(71) Applicant: MAN Energy Solutions SE, Augsburg (DE)

(72) Inventors: Andreas SCHATZINGER, Zusmarshausen (DE); Dietmar Beer, Augsburg (DE)

(21) Appl. No.: 16/401,451

(22) Filed: May 2, 2019

(30) Foreign Application Priority Data
May 3, 2018 (DE) DE102018110567.3

(51) Int. Cl. F01D 25/00; F02B 37/013; F02B 77/04

(52) U.S. Cl. CPC F01D 25/002; F05D 2270/303; F02B 77/04; F02B 37/013

(57) ABSTRACT

A turbocharger cleaning device for automatic cleaning of an internal space of a turbocharger during the operation of the turbocharger and to an associated cleaning method. The turbocharger cleaning device includes a control, which is connected to the turbocharger, to receive turbocharger parameters and designed, by activating at least one valve based on turbocharger parameters received from the turbocharger, to automatically clean the turbocharger and automatically control the flow rate of a fluid through the pipe system.

### BACKGROUND OF THE INVENTION

### 1. Field of the Invention

The invention relates to an automatic turbocharger cleaning device for cleaning a turbocharger in operation, to an associated method for cleaning the turbocharger, and to a system consisting of turbocharger and turbocharger cleaning device.

### 2. Description of the Related Art

During the operation of a turbocharger, dirt is accumulated in an internal space of the turbocharger both on a turbine side and also on a compressor side of the turbocharger. In order to be able to ensure an efficient and economical operation of the turbocharger it is necessary that the accumulated dirt is regularly removed by cleaning.

In particular in turbochargers of a certain size, for example for marine engines, but generally also in turbochargers that are permanently operated, it is mostly not possible to deactivate or disassemble the turbocharger for cleaning.

From the prior art, various cleaning devices and cleaning methods are already known but which have to be carried out manually. For performing the cleaning, the cleaning personnel have to approach the turbocharger from a safe region from a safe distance and enter a hazard region near the turbocharger. In the event of a malfunctioning of the turbocharger, situations can arise in the hazard region that pose a risk to the cleaning personnel. In addition, such a manual cleaning is cost-intensive.

### SUMMARY OF THE INVENTION

One aspect of the invention is based on overcoming the aforementioned disadvantages and provide a turbocharger cleaning device for automatically cleaning an internal space of a turbocharger during the operation and an associated method, with which the internal space of the turbocharger can be automatically cleaned in particular without having to enter the hazard region.

According to one aspect of the invention, a turbocharger cleaning device for the automatic cleaning of an internal space of a turbocharger during the operation is proposed. The turbocharger cleaning device comprises a pipe system, a cleaning agent source, and an electronic control. The pipe system joins a connector of the turbocharger, which leads into the internal space of the turbocharger to be cleaned, to the cleaning agent source, so that a fluid or cleaning agent or cleaning material can flow from the cleaning agent source through the pipe system to the connector into the internal space. The pipe system is designed, furthermore, to conduct a cleaning agent from the cleaning agent source through the connector into the internal space. The pipe system additionally comprises at least one valve for controlling a flow rate of a fluid or at least of one cleaning agent from the cleaning agent source through the pipe system. The control is connected to the turbocharger to receive turbocharger parameters so that the control is at least able to receive data from the turbocharger or from a control of the turbocharger or from a measurement device on the turbocharger. Based on the turbocharger parameters obtained from the turbocharger, the control is designed to automatically clean the turbocharger or the internal space by way of preferentially electrically activating the at least one valve in the process and in addition automatically control the flow rate of a fluid through the pipe system.

Alternatively, the turbocharger cleaning device comprises the connector, wherein the turbocharger then comprises an opening to the internal space to be cleaned receiving the connector.

In an advantageous embodiment of the turbocharger cleaning device, the pipe system comprises a temperature measurement device. The temperature measurement device is designed to measure a temperature in the pipe system on the connector. Alternatively, the temperature can also be measured in a section of the pipe system that is directly adjacent but spaced from the connector. When the temperature measured by the temperature measurement device exceeds a predetermined temperature threshold of preferentially 70° C. it is assumed that exhaust gases from the turbocharger have entered the pipe system. The entered exhaust gases result in a corrosion of the pipes of the pipe system so that the pipes are subject to increased wear. The temperature measurement device is connected to the control. When the temperature measured by the temperature measurement device exceeds the temperature threshold value, the control initiates countermeasures in order to convey the exhaust gases from the pipe system back into the turbocharger.

A further advantageous configuration version provides that the turbocharger cleaning device comprises a sealing air source and the pipe system comprises a sealing air valve. The pipe system connects the sealing air source to the connector via the sealing air valve, so that a fluid or the sealing air can flow through the pipe system from the sealing air source to the sealing air valve, from the sealing air valve to the connector and into the internal space to be cleaned. The sealing air valve is arranged in the pipe system between the sealing air source and the connector and designed to control a flow rate of a sealing air from the sealing air source through the connector into the internal space. The control is connected to the sealing air valve and controls the same so that the sealing air valve in a passage position, when the turbocharger is not cleaned or does not undergo a cleaning cycle, and the sealing air valve is in a blocking position, when the turbocharger is cleaned or undergoes a cleaning cycle. When the sealing air valve is in its passage position, the sealing air flows from the sealing air source to the connector. The sealing air has preferentially a temperature of approximately 40° C. and a pressure that corresponds at least to a pressure of the exhaust gases in the turbocharger. The pressure of the sealing air is lower than a pressure of a compressed, air which is preferentially between 6 and 60 bar. Through the pressure of the sealing air the same is designed to push exhaust gases that are present in the pipe system through the connector back into the turbocharger. By way of this, the sealing air seals the turbocharger cleaning device against exhaust gas entering from the turbocharger.

In order to prevent damage on the turbocharger cleaning device through exhaust gas entering from the turbocharger, an advantageous configuration provides that the turbocharger cleaning device comprises an emergency sealing air source and the pipe system an emergency sealing air valve. The pipe system connects the emergency sealing air source to the connector via the emergency sealing air valve, so that a fluid or the emergency sealing air can flow through the pipe system from the emergency sealing air source to the emergency sealing air valve, from the emergency sealing air valve to the connector and into the internal space to be cleaned. The emergency sealing air valve is arranged in the pipe system between the emergency sealing air source and the connector and designed to control a flow rate of an emergency sealing air from the emergency sealing air source through the connector into the internal space. The control is connected to the emergency sealing air valve and controls the same so that the emergency sealing air valve is in a passage position when the turbocharger is not cleaned or does not undergo a cleaning cycle and exhaust gas has entered the pipe system, and the emergency sealing air valve is in a blocking position, when the turbocharger is cleaned or undergoes a cleaning cycle. The fact that exhaust gas has entered the pipe system is preferentially determined by the temperature measurement device since the same in this case measures a temperature above the temperature threshold value. When the emergency sealing air valve is in its passage position, the emergency sealing air flows from the emergency sealing air source to the connector. The emergency sealing air is preferentially a compressed air with a static pressure between 6 and 60 bar. Through the pressure of the emergency sealing air the same is designed to push exhaust gases that are present in the pipe system through the connector back into the turbocharger. By way of this, the emergency sealing air seals the turbocharger cleaning device against exhaust gas entering from the turbocharger. The emergency sealing air valve is activated by the control so that upon a failure of the sealing of the pipe system by the sealing air it is in passage position, wherein the sealing air valve in this case is brought into the blocking position by the control so that the emergency sealing air cannot flow to the sealing air source.

For controlling the cleaning agent, an advantageous further development provides that the pipe system comprises a cleaning agent valve. The cleaning agent valve is arranged in the pipe system between the cleaning agent source and the connector so that the cleaning agent can flow from the cleaning agent source through the cleaning agent valve to the connector into the internal space. The cleaning agent valve is designed to control a flow rate of the cleaning agent from the cleaning agent source through the connector into the internal space.

In an advantageous embodiment, the turbocharger cleaning device comprises a control air source and the pipe system a control valve. The pipe system connects the control air source with the cleaning agent valve via the control valve, so that a fluid or the control air can flow through the pipe system from the control air source to the control valve and from the control valve to the cleaning agent valve. The cleaning agent valve is designed as a pinch valve and the control valve is arranged in the pipe system between the control air source and the cleaning agent valve. The control valve is designed to control a flow rate of a control air from the control air source through a control connection of the pinch valve into a control space of the pinch valve. The control valve is connected to the control which controls the control valve. When the control valve is in a passage position, the control air flows into the control space of the cleaning agent valve, builds up a pressure in the control space and thereby narrows the passage cross section of the cleaning agent valve, so that the same permits passing of less or no cleaning agent. When the control valve is in its blocking position, no control air flows into the control space but escapes from the control space, so that the pressure in the control space drops and the passage cross section of the cleaning agent valve increases in size. Because of this, the cleaning agent valve permits (more) cleaning agent to pass.

In a further advantageous design of the turbocharger cleaning device, the control air source and the emergency sealing air source are a common compressed air source, from which compressed air as control air and emergency sealing air flows into the pipe system.

In particular for the case that a granulate is used as a cleaning agent, an advantageous configuration of the turbocharger cleaning device provides that the cleaning agent source comprises a cleaning agent container. Atmospheric pressure is present in the cleaning agent container, which corresponds to the average ambient pressure in a space in which the turbocharger is arranged. The cleaning agent container additionally has a volume which corresponds to a multiple of a volume of the cleaning agent that is consumed during an intended cleaning cycle during a cleaning of the internal space. Because of the volume of the cleaning agent container it is not necessary to replace or replenish the cleaning agent container after every cleaning cycle so that no manual operations have to be carried out on the turbocharger cleaning device over an extended period of time.

When the cleaning agent is a granulate and the cleaning to be carried out with it is a dry cleaning, a conveying agent is needed with which the granulate can flow through the pipe system into the internal space. An advantageous further development therefore provides that the turbocharger cleaning device comprises a conveying agent source and the pipe system a conveying agent valve and a venturi nozzle. The pipe system connects the conveying agent source via the venturi nozzle and via the cleaning agent valve with the connector, so that the conveying agent, when the conveying agent valve is in its passage position, flows through the conveying agent valve into the venturi nozzle in which it drags the cleaning agent along with it. The mixture of conveying agent and cleaning agent then flows out of the venturi nozzle through the cleaning agent valve through the connector into the internal space. The cleaning agent valve is arranged in the pipe system between the conveying agent source and the venturi nozzle and designed to control a flow rate of a conveying agent from the conveying agent source through the venturi nozzle, the cleaning agent valve and the connector into the internal space. The venturi nozzle is designed to create an underpressure with the conveying agent flowing through, which transports the cleaning agent from the cleaning agent container into the conveying agent, so that the cleaning agent, mixed with the conveying agent or as a mixture of conveying agent and cleaning agents can be conveyed into the internal space of the turbocharger. The conveying agent is preferentially compressed air, wherein the conveying agent source, the control air source and the emergency sealing air source furthermore are preferentially a common compressed-air source.

Furthermore, according to one aspect of the invention, a system consisting of a turbocharger and a turbocharger cleaning device is proposed. The internal space of the turbocharger to be cleaned is a turbine side of the turbocharger or a compressor side of the turbocharger.

According to one aspect of the invention, a cleaning method for cleaning a turbocharger with a turbocharger cleaning device during the operation of the turbocharger is additionally proposed. The sole turbocharger parameter received by the control of the turbocharger cleaning device from the turbocharger or the motor is exclusively a turbocharger rotational speed. The control compares the turbocharger rotational speed at predetermined intervals with a set rotational speed. When the turbocharger rotational speed reaches the set rotational speed, the control activates the at least one valve of the pipe so that cleaning agent is conducted through the pipe system into the internal space of the turbocharger. The cleaning agent is conducted into the internal space for a predetermined time following the expiration of which the control brings the valve from its passage position into its blocking position. Within this time, a predetermined volume of the cleaning agent is thereby conducted into the internal space during the cleaning method. A pass or run of a cleaning method corresponds to a cleaning cycle. The cleaning method is preferentially repeated automatically at predetermined intervals of for example days or weeks. Alternatively or additionally, the command for cleaning can come from an external signal source.

The cleaning method for the cleaning the turbocharger is a dry cleaning method or a wet cleaning method. In the case of the dry cleaning method, the cleaning agent is a granulate, preferentially a nut shell granulate or an activated carbon granulate with an average diameter of 1.5 mm. In the case of the wet cleaning method, the cleaning agent is a liquid, preferentially sweet water, which can be optionally mixed with additives for cleaning. When the cleaning agent is a liquid, the cleaning agent source is preferentially a tank or a pipe system, such as for example water pipes, which provides the liquid at the turbocharger cleaning device.

With the cleaning method, the set rotational speed in an advantageous embodiment is a full load rotational speed of the turbocharger, at which the turbocharger is operated with its maximum continuous load. Alternatively, the set rotational speed is between 20 and 40% of the full load rotational speed of the turbocharger. In particular with the dry cleaning or the dry cleaning method, the set rotational speed is the full load rotational speed. With the wet cleaning or the wet cleaning method, the set rotational speed can be the full load rotational speed but preferentially is between 20 and 40% of the full load rotational speed so that the turbocharger is exposed to a lower thermal load and, during the introduction of the liquid into the internal space, lower temperature differences between the liquid and the turbocharger occur, so that a thermal shock loading is minimised.

Here, a configuration of the cleaning method is also advantageous, during which the control activates the valve only after a waiting time following the reaching of the set rotational speed. The waiting time serves for thermally adapting the turbocharger so that it can cool down within the waiting time. Because of this, in particular during the introduction of the liquid with the wet cleaning method, the turbocharger is exposed to lower loads through temperature differences or through a thermal shock, i.e. a sudden change in temperature.

Additionally proposed is an advantageous further development of the cleaning method with which the control activates the sealing air valve so that it is in a passage position, when no cleaning agent is conducted through the pipe system from the cleaning agent source through the connector into the internal space, so that sealing air is conducted from the sealing air source into the internal space. Furthermore, the sealing air valve is activated by the control so that it is in a blocking position when cleaning agent is conducted into the internal space so that the cleaning agent cannot flow to the sealing air source. The emergency sealing air valve, if present, is likewise activated so that during a cleaning operation it is in a blocking position, so that the cleaning agent does not flow to the emergency sealing air source.

For protecting the pipe system, a further development of the cleaning method is advantageous, in which the control activates the emergency sealing air valve so that it is in a passage position when the temperature measurement device in the pipe system measures an actual temperature, which is above a set temperature, so that emergency sealing air is conducted from the emergency sealing air source into the internal space. Exhaust gas in the pipeline, which causes the rise of the actual temperature above the set temperature, is conveyed or pushed by the emergency sealing air out of the pipe system into the turbocharger because of this.

Preferentially, the turbine side of the turbocharger can be cleaned with the dry cleaning method or the wet cleaning method and the compressor side of the turbocharger with the wet cleaning method.

The turbocharger cleaning device can also be integrated or attached in the case of existing turbochargers so that it can be retrofitted.

In the case of the wet cleaning method, the liquid can be additionally mixed with cleaning additives in the pipe system by a mixing device.

The features disclosed above can be combined in any way provided this is technically possible and these do not contradict one another.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Other advantageous further developments of the invention are characterized in the subclaims or are explained in more detail in the following together with the description of the preferred embodiment of the invention by way of the figures. It shows:

FIG. 1 is a turbocharger cleaning device for the dry cleaning of a turbocharger; and

FIG. 2 is a turbocharger cleaning device for the wet cleaning of a turbocharger.

### DETAILED DESCRIPTION OF THE PRESENTLY PREFERRED EMBODIMENTS

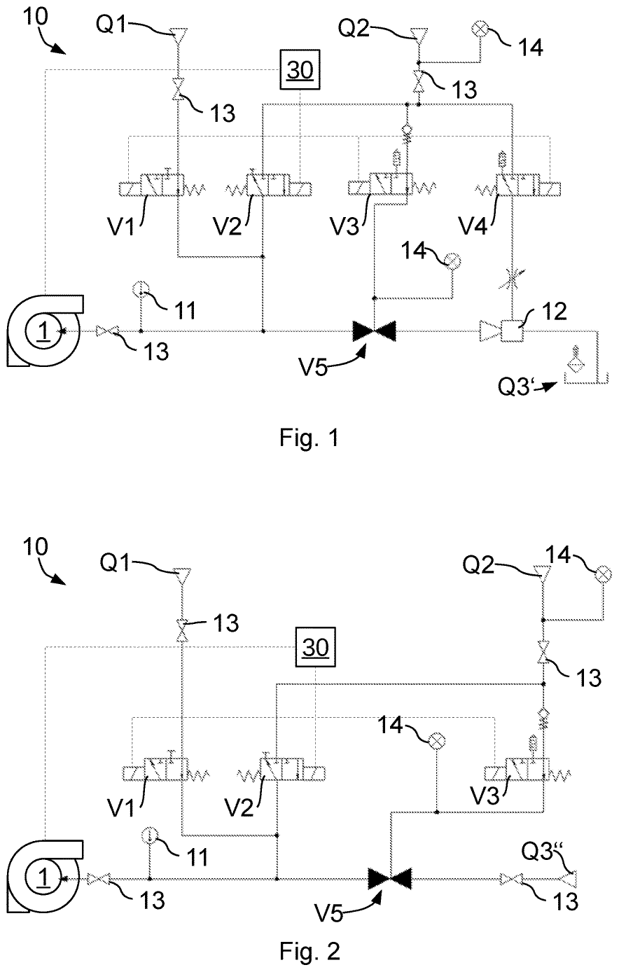

FIG. 1 shows a turbocharger cleaning device for the dry cleaning of a turbocharger 1 or of the turbine side of the turbocharger 1. For this purpose, the turbocharger cleaning device comprises a pipe system 10, a sealing air source Q1, a compressed air source Q2 and a cleaning agent container Q3′. A respective shut-off valve 13 is provided in the pipe system 10 after the sealing air source Q1 and the compressed air source Q2 as well as in front of the connector of the turbocharger 1. In order to switch the pipe system 10 or at least parts thereof pressureless for maintenance purposes. The control 30 is connected to the turbocharger 1 and from it receives the actual rotational speed of the turbocharger 1 or of the turbocharger turbine. In addition to this, the control 30 is connected to the valves V1 to V4 or the control coils of the valves V1 to V4 in order to be able to move the valves V1 to V4 into a blocking position or into a passage position through activation. The connection of the valves V1 to V4 and of the turbocharger 1 to the control 30 is shown in the Figures by dashed lines. In addition, the control 30 is connected to the temperature measurement device 11 and the pressure switches 14, which is not shown. The pressure switches 14 transmit to the control 30 the current pressure or at least the exceeding or undershooting of a preset pressure in the respective section of the pipe section 10, in which they are arranged.

When the turbocharger 1 is not being cleaned, the control 30 switches the sealing air valve V1 into its passage position, so that sealing air is conducted from the sealing air source Q1 into the turbocharger and exhaust gases of the turbocharger are no longer able to enter the pipe system 10. Should exhaust gases nevertheless enter the pipe system 10, for example because the sealing air source Q1 does not supply any or sufficient sealing air, the increased temperature is measured by the temperature measurement device 11, which determines the actual temperature at regular intervals and transmits it to the control 30. When an actual temperature that is elevated above a set temperature is signalled by the temperature measurement device 11 to the control 30, the control 30 switches the sealing air valve V1 into its blocking position and the emergency sealing air valve V2 into its passage position. With the emergency sealing air valve V2 in the passage position, compressed air can flow from the compressed air source Q2 via the connector that is not shown into the turbocharger 1 and thus pushes exhaust gas that has entered the pipe system 10 back into the turbocharger 1. The control valve V3 activates the pinch valve V5. When the turbocharger 1 is not being cleaned, the control valve V3 is in the passage position so that compressed air can flow into a control chamber of the pinch valve V5 and thus cuts off the flow from the venturi nozzle 12 to the turbocharger 1. For cleaning the turbocharger 1, the control switches the sealing air valve V1, the emergency sealing air valve V2 and the control valve V3 into the respective blocking position for a predetermined time and the conveying agent valve V4 into the passage position. The compressed air flows from the compressed air source Q2 through the conveying agent valve into the venturi nozzle 12. In the venturi nozzle 12, the compressed air flowing past drags granulate out of the cleaning agent container Q3 with it so that the granulate is mixed with the compressed air. The compressed air with the granulate flows out of the venturi nozzle through the pinch valve V5 and through the connector into the internal space of the turbocharger located on the turbine side. In the internal space, the granulate acts as cleaning agent for cleaning the turbocharger. The control 30 initiates the cleaning operation in the shown exemplary embodiment at regular intervals of seven days as soon as the turbocharger rotational speed transmitted to the control corresponds to a set rotational speed stored in the control 30, which is the full load rotational speed.

FIG. 2 likewise shows a turbocharger cleaning device for cleaning a turbocharger 1 or the turbine side of the turbocharger 1. However, the turbocharger cleaning device is designed for a wet cleaning of the turbocharger 1. Each of the components have the same function, but in the embodiment shown in the FIG. 2, the conveying agent valve V4 and the venturi nozzle are omitted, since the liquid does not require any additional conveying agent. The liquid is provided by a liquid source Q3″, so that the liquid during a cleaning operation flows into the turbocharger 1 by the pressure provided by the liquid source Q3″.

In its embodiment, the invention is not restricted to the preferred exemplary embodiments stated above. On the contrary, a number of versions is conceivable which makes use of the shown solution even with fundamentally other types of embodiments. For example, the turbocharger cleaning device can provide a switch unit, by way of which the two cleaning agent containers are connectable to the connector via the pipe system, so that by the turbocharger cleaning device both a dry and also a wet cleaning method can be carried out.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A turbocharger cleaning device for automatic cleaning of an internal space of a turbocharger during operation, comprising:
a pipe system configured to connect a connector of the turbocharger and leads into the internal space of the turbocharger to be cleaned comprising at least one valve;
a cleaning agent source configured to be connected to the internal space by the pipe system to conduct a cleaning agent from the cleaning agent source through the connector into the internal space, wherein the at least one valve controls a flow rate of the cleaning agent through the pipe system; and
an electronic control, wherein the control is connected to the turbocharger in order to receive turbocharger parameters, and designed by activating the at least one valve based on turbocharger parameters received from the turbocharger, to automatically clean the turbocharger and automatically control the flow rate of a fluid through the pipe system.

2. The turbocharger cleaning device according to claim 1, wherein the pipe system comprises:
a temperature measurement device configured to measure a temperature in the pipe system at the connector.

3. The turbocharger cleaning device according to claim 1, further comprising:
a sealing air source and
a sealing air valve arranged in the pipe system that connects the sealing air source with the connector,
wherein the sealing air valve in the pipe system is arranged between the sealing air source and the connector and configured to control a flow rate of a sealing air from the sealing air source through the connector into the internal space.

4. The turbocharger cleaning device according to claim 1, further comprising:
an emergency sealing air source; and
an emergency sealing air valve arranged in the pipe system that connects the emergency sealing air source with the connector,
wherein the emergency sealing air valve is arranged in the pipe system between the emergency sealing air source and the connector and configured to control a flow rate of an emergency sealing air from the emergency sealing air source through the connector into the internal space.

5. The turbocharger cleaning device according to claim 4, further comprising:
a cleaning agent valve arranged in the pipe system between the cleaning agent source and the connector and configured to control a flow rate of the cleaning agent from the cleaning agent source through the connector into the internal space.

6. The turbocharger cleaning device according to claim 5, further comprising:
a control air source; and
a control valve arranged in the pipe system, the pipe system connects the control air source with the cleaning agent valve,
wherein the cleaning agent valve is a pinch valve and the control valve in the pipe system is arranged between the control air source and the cleaning agent valve and configured to control a flow rate of a control air from the control air source through a control connection of the pinch valve into a control space of the pinch valve.

7. The turbocharger cleaning device according to claim 6, wherein the control air source and the emergency sealing air source are a common compressed air source.

8. The turbocharger cleaning device according to claim 1, wherein the cleaning agent source comprises:
a cleaning agent container, in which atmospheric pressure is present and which has a storage volume corresponding to a multiple of a volume of the cleaning agent consumed during an intended cleaning cycle.

9. The turbocharger cleaning device according to claim 8, further comprising:
a conveying agent source;
a conveying agent valve in the pipe system; and
a venturi nozzle coupled to the conveying agent source via and the pipe system;
wherein the cleaning agent valve is coupled to the connector via and the pipe system,
wherein the conveying agent valve is arranged in the pipe system between the conveying agent source and the venturi nozzle and configured to control a flow rate of a conveying agent from the conveying agent source through the venturi nozzle, the cleaning agent valve and the connector into the internal space, wherein the venturi nozzle is configured with the conveying agent flowing through to create an underpressure which transports the cleaning agent from the cleaning agent container into the conveying agent so that the cleaning agent, mixed with the conveying agent, can be conveyed into the internal space of the turbocharger.

10. A system consisting of a turbocharger and a turbocharger cleaning device according to claim 1, wherein the internal space to be cleaned is a turbine side of the turbocharger or a compressor side of the turbocharger.

11. A cleaning method for cleaning a turbocharger with a turbocharger cleaning device having a pipe system configured to connect a connector of the turbocharger and leads into an internal space of the turbocharger to be cleaned comprising at least one valve, a cleaning agent source configured to be connected to the internal space by the pipe system to conduct a cleaning agent from the cleaning agent source through the connector into the internal space, wherein the at least one valve controls a flow rate of the cleaning agent through the pipe system; and an electronic control, wherein the control is connected to the turbocharger in order to receive turbocharger parameters, and designed by activating the at least one valve based on turbocharger parameters received from the turbocharger, to automatically clean the turbocharger and automatically control the flow rate of a fluid through the pipe system, comprising:
comparing by the control a turbocharger rotational speed with a set rotational speed, wherein the turbocharger rotational speed is an only turbocharger parameter; and
activating, by the control, the at least one valve of the pipe so that cleaning agent is conducted through the pipe system into the internal space of the turbocharger when the set rotational speed is reached,
wherein the cleaning agent conducted into the internal space has a predetermined volume.

12. The cleaning method according to claim 11, wherein one of:
the cleaning method is a dry cleaning method and the cleaning agent is a granulate and
the cleaning method is a wet cleaning method wherein the cleaning agent is a liquid.

13. The cleaning method according to claim 11, wherein the set rotational speed is one of a full load rotational speed of the turbocharger and between 20 and 40% of the full load rotational speed of the turbocharger.

14. The cleaning method according to claim 11, wherein the control activates the at least one valve only following a waiting time after the reaching of the set rotational speed.

15. The cleaning method according to claim 11, wherein the control activates a sealing air valve, so that it is in a passage position, when no cleaning agent is conducted through the pipe system from the cleaning agent source through the connector into the internal space, so that sealing air is conducted from a sealing air source into the internal space.

16. The cleaning method according to claim 11, wherein the control activates an emergency sealing air valve so that it is in a passage position when a temperature measurement device in the pipe system measures an actual temperature above a set temperature, so that emergency sealing air is conducted from an emergency sealing air source into the internal space.
